(19) United States
(12) Patent Application Publication
(10) Pub. No.: US 2025/0125325 A1
(43) Pub. Date: Apr. 17, 2025

(54) SYSTEMS AND METHODS FOR ELECTRODE MANUFACTURING

(71) Applicant: Ford Global Technologies, LLC, Dearborn, MI (US)

(72) Inventors: Ann Straccia, Southgate, MI (US); Eric Poczatek, Westland, MI (US); Yun Bai, Canton, MI (US); Joy Forsmark, Saint Clair Shores, MI (US)

(21) Appl. No.: 18/487,840

(22) Filed: Oct. 16, 2023

(51) Int. Cl. H01M 4/04; H01M 4/62; H01M 4/88

(52) U.S. Cl. CPC H01M 4/0404; H01M 4/0409; H01M 4/0416; H01M 4/622; H01M 4/8832

(57) ABSTRACT

Methods and systems are provided for manufacturing an electrode by binder jetting. In one example, a method may include coating a current collector with powder including electroactive material particles and applying binder by jetting an ink including binder in a controlled pattern on to the powder coated current collector. Jetting the ink forms an electrode with patterned areas of bound powder and unbound powder, with the unbound powder secured between the areas of bound powder.

### FIELD

The present description relates generally to methods and systems for manufacturing an electrode of a battery.

### BACKGROUND/SUMMARY

Manufacturing of electrodes at scale often includes preparation of a slurry including at least electrode active material particles and binder in a solvent. The slurry may be applied as a layer to a current collector by a mass manufacturing process, such as slot die coating, followed by a drying step in which the solvent is removed, leaving behind the electrode active material particles held in place with binder. While the binder may be evenly dispersed when wet, upon drying the binder may become more dense in certain areas of the electrode, leaving some areas of the electrode with weak adhesion/film cohesion. Additionally, the binder may not be conductive and hinders electron and/or ion flow through the electrode. For these reasons, controlled application of the binder as well as minimizing an amount of binder in the electrode may be desired.

Attempts to decrease electrode manufacturing time by reducing drying time include applying binder directly to electrode active material particles without solvent. However, the inventors herein have recognized potential issues with such methods. As one example, applying binder/solvent mixture directly to electrode active material particles without forming a slurry may result in an inhomogeneous electrode where density of electrode active material particles varies spatially in an uncontrolled fashion across the electrode. Such inhomogeneity may result in areas of poor conductivity and cause degradation of the battery. Additionally, applying binder in this manner may also result in an excess of the insulating binder applied to the electrode, thereby decreasing conductivity of the electrode.

In one example, the issues described above may be addressed by a method comprising coating powder onto a first current collector, wherein the powder includes electroactive material particles, jetting an ink including a binder in a controlled pattern onto the powder coated first current collector, and forming an electrode including patterned areas of bound powder and unbound powder, wherein the unbound powder is secured between the patterned areas of bound powder. In this way, binder is applied in a layer by layer fashion to a bed of electrode active material in a controlled and reproducible pattern which employs minimal solvent and decreases electrode manufacturing time. Controlling binder application in this way provides flexibility to tailor electrode structures to optimize battery performance as desired for different applications.

As one example, a density of the electrode active material particles on the electrode may be adjusted to account for electrode swelling during multiple charging and discharging cycles. Further, the binder ink may also incorporate other electrode additives such a dopant or a thermally activated catalyst which may be conductive to further decrease internal resistance of the battery. In this way, structure and composition of the electrode may be controlled on the micron scale with minimal use of solvent.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example of a process flow diagram for manufacturing a battery array.

FIG. 2 shows a first example of electrode manufacturing using a binder jet system.

FIG. 3 shows a second example of electrode manufacturing using the binder jet system.

FIG. 4 shows a flow chart of an example of a method for electrode manufacturing using the binder jet system.

FIG. 5A shows an illustration of binder deposition as a result of dispensing binder using the binder jet system.

FIG. 5B shows an illustration of electroactive material particles bound after binder deposition as illustrated in FIG. 5A.

FIG. 6A shows an example of a first pattern printed by the binder jet system.

FIG. 6B shows a magnified view of the first pattern of FIG. 6A.

FIG. 6C shows a three dimensional illustration of the first pattern printed by the binder jet system.

FIG. 7 shows an illustration of high ink density and low ink density areas.

FIG. 8 shows an example of a second pattern printed by the binder jet system.

FIG. 9 shows an illustration of bound and unbound electroactive material particles of the second pattern of FIG. 8.

### DETAILED DESCRIPTION

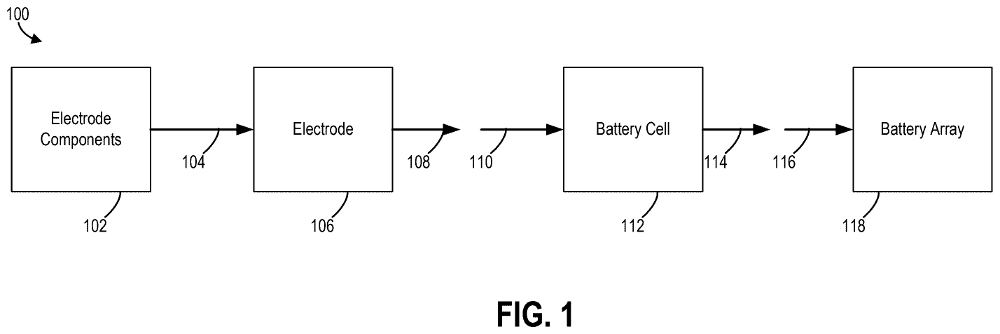

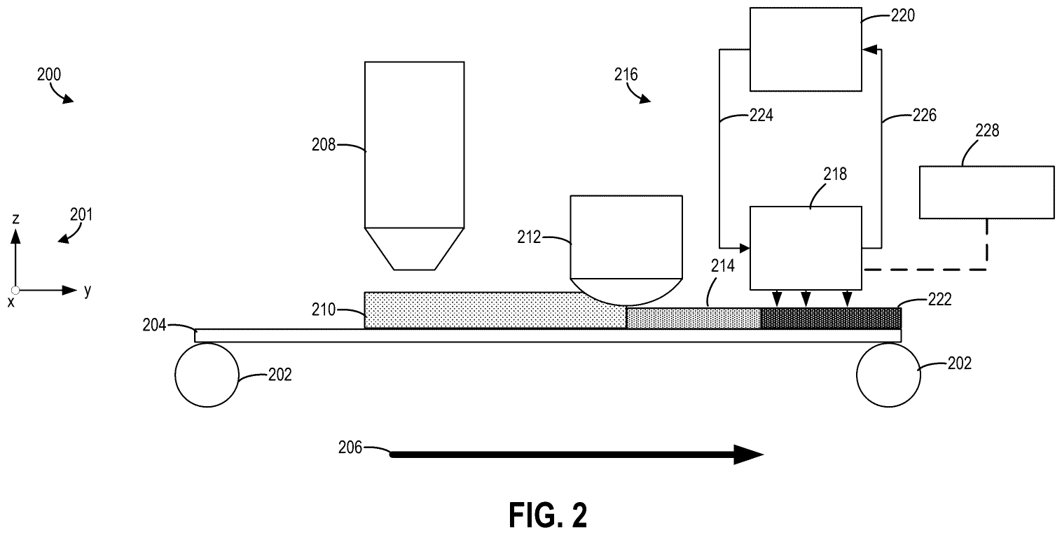

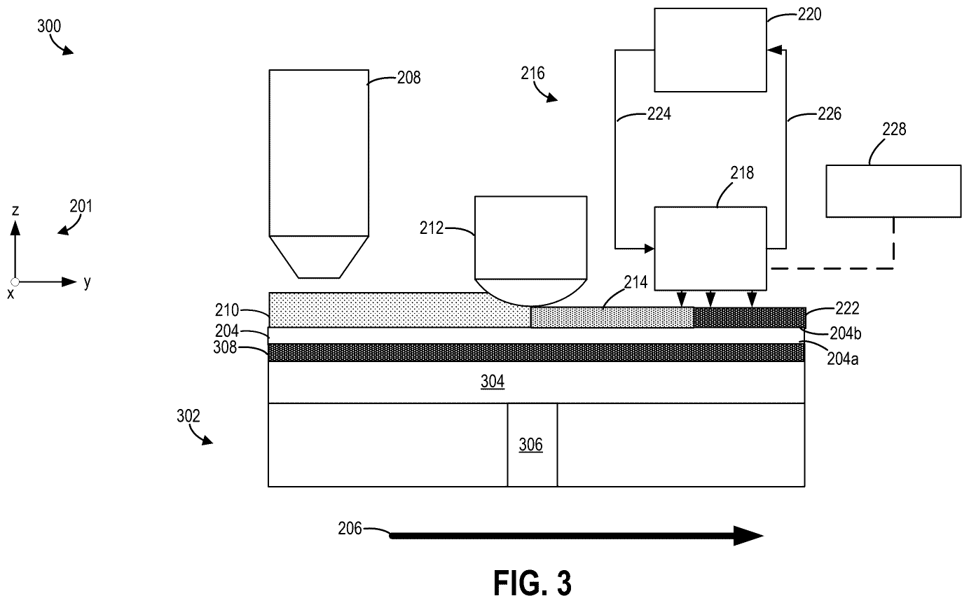

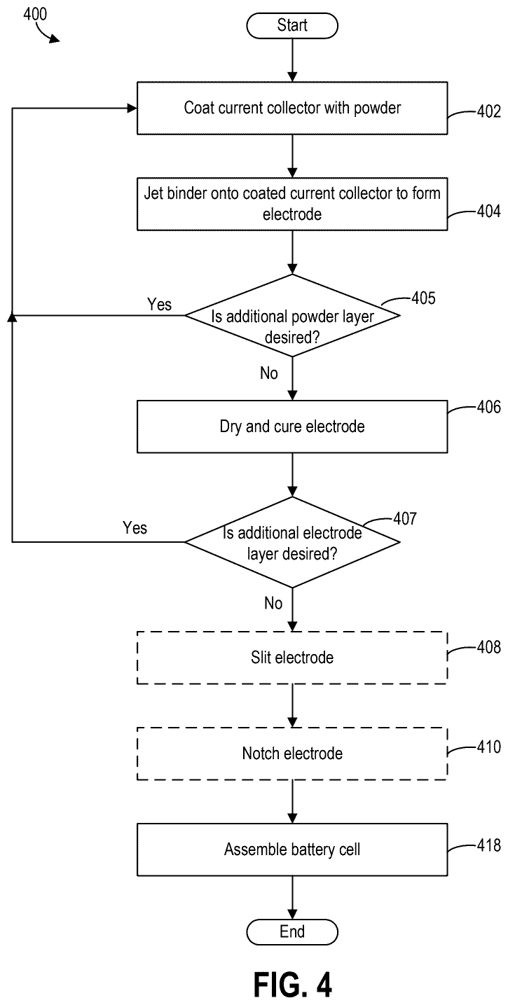

The following description relates to systems and methods for manufacturing electrodes which are assembled into a battery cell. A plurality of battery cells may be packaged together to form a battery array which may be used across a wide range of applications, including providing an energy source for a vehicle. A process flow diagram for manufacturing a battery array from electrode raw materials is shown in FIG. 1. One of the steps in the process flow diagram is electrode manufacturing. A process time associated with electrode manufacturing may be decreased by using a binder jet system to apply an ink including a binder to electroactive material particles. Herein, electroactive material particles may be particles which participate in an electrochemical reaction of a battery. For example, electroactive material particles may include anode electroactive material particles or cathode electroactive material particles. The binder jet system may be adapted from a binder jet printer used in additive manufacturing. Briefly, an inkjet head may be coupled to precision servo motors to precisely control movement of the inkjet head in an x-y plane, parallel to a substrate. The binder jet system includes a controller configured to provide instructions for positioning of the inkjet printhead and for dispensing the ink from the inkjet head with a precise droplet shape and saturation level. In this way, a precise two dimensional pattern of ink is distributed. The process is repeated for multiple layers of powder to form a three dimensional structure. Two examples of an electrode manufacturing process using the binder jet system are shown in FIGS. 2 and 3 respectively. An example of a method for electrode manufacturing and preassembly using binder jetting is shown in FIG. 4.

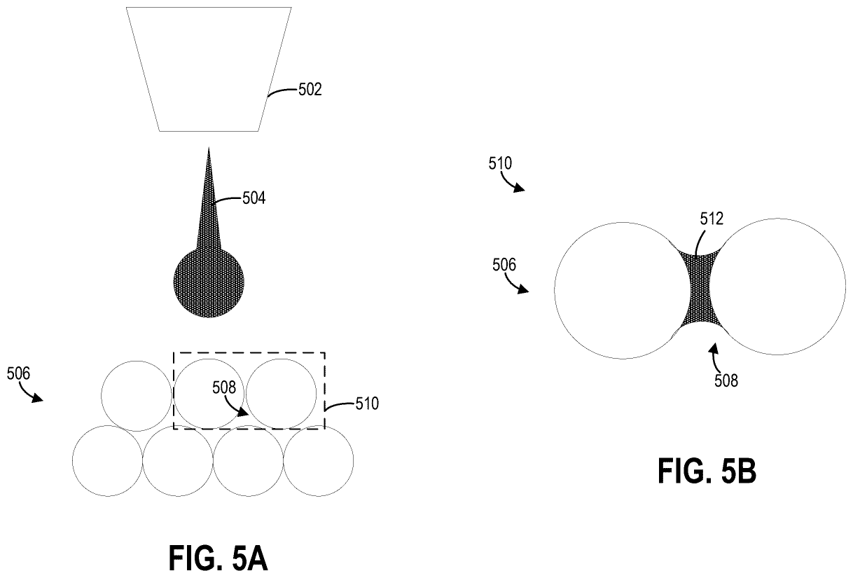

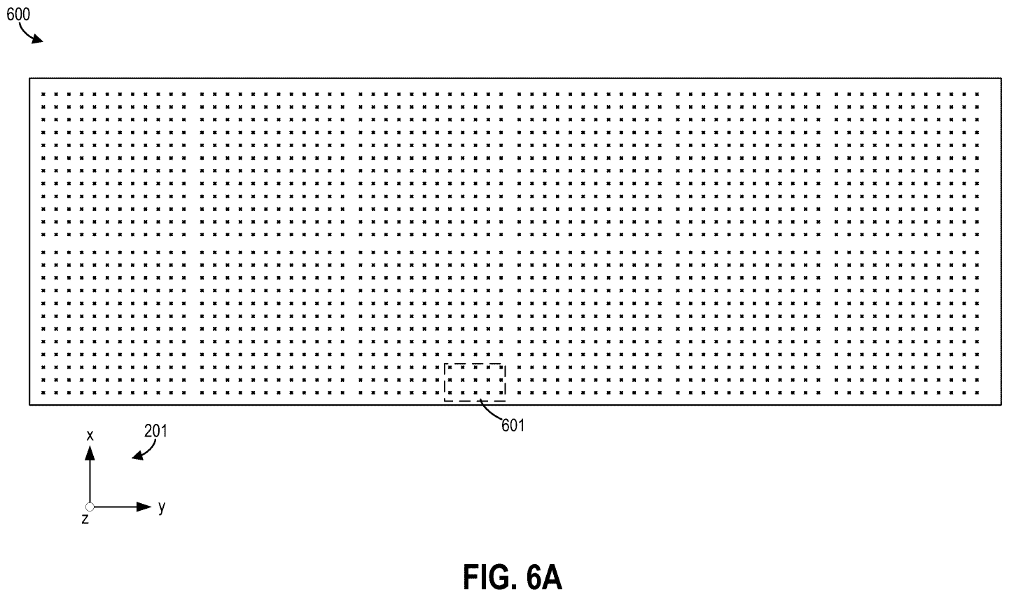

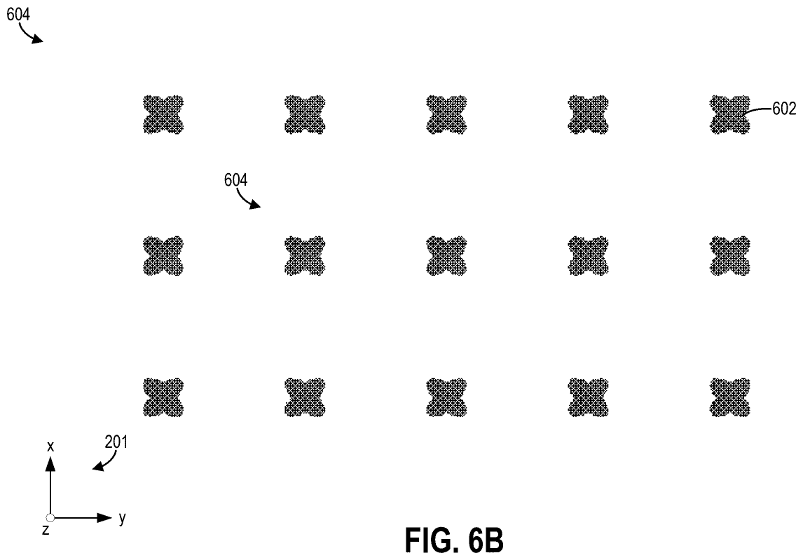

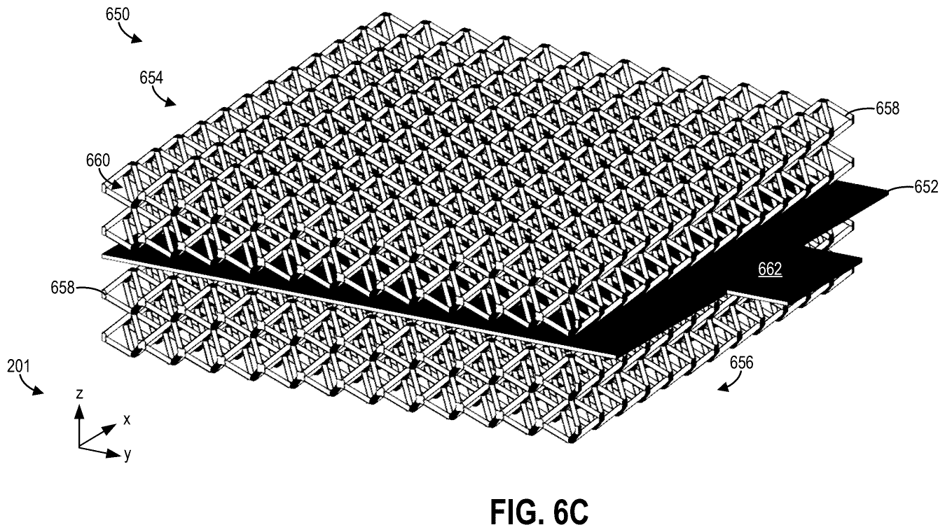

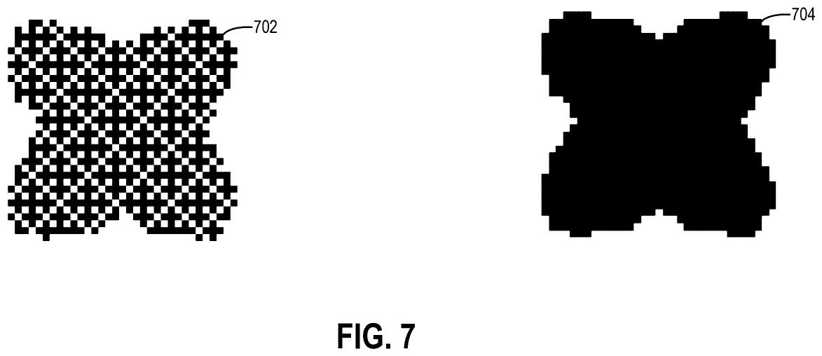

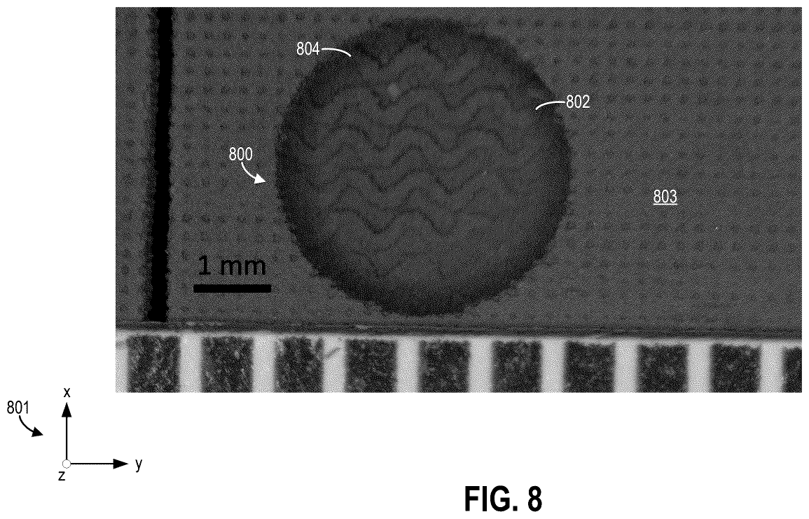

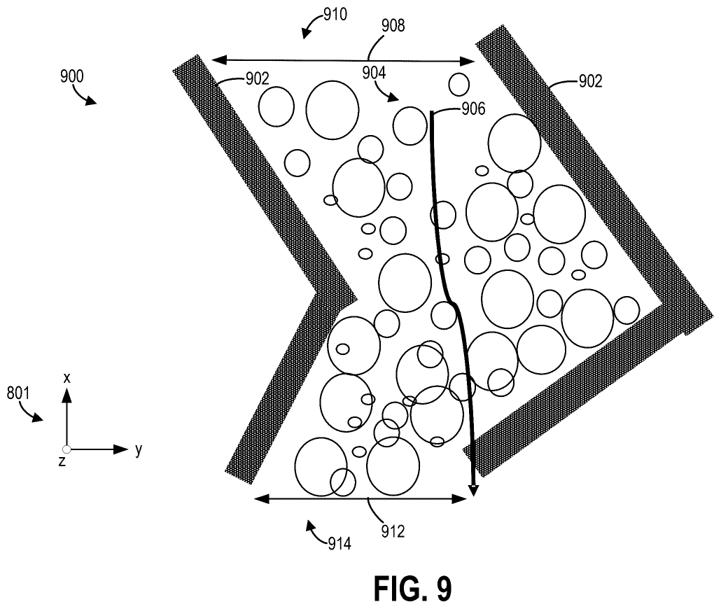

An electrode structure including patterned areas of bound electroactive material particles and unbound electroactive material particles may be purposefully adjusted by using the binder jet system to pattern binder onto the electrode active material particles. An example of how binder may be deposited onto a bed of electroactive material particles is shown in FIGS. 5A-5B. An illustration of a possible pattern is shown in FIG. 6A-6C. In addition to controlling the pattern of bound electroactive material particles, the binder jet system may controllably print high ink density and low ink density areas. An illustration showing an examples of high ink density and low ink density is shown in FIG. 7. At the particulate level, dispensing binder in patterns and varying densities as shown in FIGS. 6A-6C and 7 may provide a lattice of bound and unbound electroactive material particles. A photograph of an example of a lattice formed by jetting binder in a layer by layer fashion is shown in FIG. 8. The example lattice of FIG. 8 may include both bound and unbound particles. An illustration of bound and unbound particles of the example of FIG. 8 is shown in FIG. 9.

Turning now to FIG. 1, a process flow diagram 100 for manufacturing a battery array is shown. Electrode components 102 may include electrode active material particles. The electrode active material particles may be either cathode active material particles or anode active material particles. In one example, the electrode active material particles may have a D50 of <20 μm. In alternate examples, the electrode active material particles may have a D50 of <15 μm. In further examples, the electrode active material particles may have a D50 of <5 μm. In an exemplary embodiment, the electrode active material particles may be electrode active materials of a lithium ion battery, configured to intercalate and de-intercalate lithium ions.

Electrode components 102 may further include a current collector. The current collector may be a sheet of electrically conductive metal, such as aluminum or copper, on which electrode active material particles are coated. Electrode components 102 may further include a binder and a solvent. The binder may be configured to fixedly couple the electrode active material particles to each other and to the current collector. The binder may be a polymer material which is dissolved in a solvent carrier for manufacturing. Electrode components 102 may further include additional additives for enhancing battery performance, including but not limited to a conductivity enhancing dopant or supplemental lithium sources.

Electrode manufacturing process 104 may produce an electrode 106 from electrode components 102. The electrode 106 may include the electroactive material particles and binder applied to the current collector. Electrode manufacturing process 104 may include pressing powdered material including electroactive material powders onto the current collector and jetting the binder dissolved in the solvent carrier onto powdered material. Additionally, electrode manufacturing process 104 may include slitting the coated current collector. Electrode manufacturing process 104 may be described in further detail below with respect to FIGS. 2-4.

Electrode 106 may further undergo pre-assembly manufacturing process 108 and cell assembly process 110 to a battery cell 112. Pre-assembly manufacturing process 108 may include drying and notching the electrode. Herein, drying refers to removing solvent from the electrode. In some examples, pre-assembly manufacturing process 108 may also include curing, wherein the binder is further cross-linked. The drying process is different from the curing process. Because electrode manufacturing process 104 uses binder jetting, the drying step of the pre-assembly manufacturing process may be faster than when high solvent electrode manufacturing process are used such as slurry coating and calendaring. Notching the electrode may form the one or more tabs of the electrode 106.

Cell assembly 110 may include stacking or laminating multiple electrodes (such as electrode 106) and inserting the multiple electrodes into a pouch. Additionally, cell assembly 110 may include filling electrolyte, forming, and ageing. The battery cell 112 may then undergo electrochemical testing 114. The electrochemical testing 114 may be followed by array assembly 116 to form a battery array 118. Array assembly 116 may include stacking and compressing multiple battery cells (such as battery cell 112) into a housing and electrically coupling the multiple battery cells via a bus bar.

As shown in FIG. 1, a process for manufacturing a battery array may include many steps. Decreasing a processing time for any of the steps may help increase efficiency of the process. When an electrode manufacturing process uses a solvent based slurry to homogeneously coat a current collector with electrode active material particles and binder, a large, energy intensive oven may be demanded for solvent removal. Additionally, the solvent may be toxic and an expensive solvent recovery system may be demanded. By eliminating the slurry and instead jetting a binder solution onto the electroactive material powder, an amount of solvent and binder used in the electrode manufacturing process may be decreased, thereby decreasing the time of equipment demanded for drying. Additionally, minimizing an amount of binder included in the electrode may increase conductivity of the electrode and decrease an overall amount of materials included in the electrode. Further, by using jetting to apply the binder, a pattern (e.g., a lattice) of bound electroactive material particles may be formed in a layer by layer fashion. The layers and pattern may be adjusted to account for swelling of the electrode and thereby increase a usable lifetime of the battery cell and battery array including the battery cell.

Turning now to FIG. 2, an illustration of a first embodiment of an electrode manufacturing system 200 using a binder jet system is shown. An axis system 201 is provided for comparison between FIGS. 2 and 3. The z-axis may be parallel to a direction of gravity. The x-axis may correspond to a lateral direction and the y-axis may correspond to a longitudinal direction. Electrode manufacturing system 200 may be similar to electrode manufacturing process 104 of FIG. 1 and may be a step in manufacturing a battery array. Electrode manufacturing system 200 may be a roll-to-roll process and may include rollers 202 which may rotate in a direction to advance a current collector 204 in a forward longitudinal direction indicated by arrow 206.

The current collector 204 may be a conductive metal foil, such as aluminum or copper as described above with respect to electrode components 102. Moving in the forward longitudinal direction, the current collector 204 may first pass under a powder dispensing unit 208. Powder dispensing unit 208 may include powdered electrode components including electroactive material particles as well as other optional powdered electrode components such as a conductivity enhancing additives, thermally activated catalysts, and/or additional lithium sources. In this way, the additional electrode components may be distributed evenly throughout the electrode. Powder dispensing unit 208 may form a loose powder layer 210 in face sharing contact with current collector 204. A density of the loose powder layer 210 may be controlled by controlling a speed of the rollers and a dispensing rate of powder dispensing unit 208.

The current collector 204 including loose powder layer 210 may be advanced in the forward longitudinal direction by rollers 202 and pass under powder leveling/compacting unit 212. Powder leveling/compacting unit 212 may compress loose powder layer 210 to form a dense powder layer 214. Powder leveling/compacting unit 212 may additionally level loose powder layer 210, making dense powder layer 214 level in the x-y plane. A density of dense powder layer 214 may be controlled by controlling a force applied by powder leveling/compacting unit 212.

The current collector 204 including dense powder layer 214 may be advanced in the forward longitudinal direction by rollers 202 and pass under binder jet system 216. Binder jet system 216 may include an inkjet printhead 218 and an ink recirculation system 220. An ink may be a solution of a binder (e.g., a polymer) in an appropriate solvent. In some examples, the ink may additionally include a conductivity enhancing dopant, a thermally activated catalyst and/or an additional lithium source. In this way, the additional electrode components may be selectively placed within the bound volume of electroactive particles. An amount of the binder per volume in the solvent may be maximized to allow for a minimal amount solvent while maintaining a viscosity low enough to dispense the solution through inkjet printhead 218. An ink recirculation system 220 may be fluidly coupled to inkjet printhead 218, such that the ink recirculation system 220 may be configured to circulate solution to the inkjet printhead 218 following arrow 224 and to circulate solution from inkjet printhead 218 back to ink recirculation system 220 following arrow 226. Circulating ink in this way may help prevent formation of a sediment and clogging of the inkjet printhead 218.

Inkjet printhead 218 may be configured to move in the lateral direction along the x-axis and dispense the ink onto dense powder layer 214, forming bound powder layer 222. Bound powder layer 222 and current collector 204 may together comprise an electrode such as electrode 106 of FIG. 1. The inkjet printhead 218 may be communicatively coupled to a control system 228. Control system 228 may include a human machine interface such as a keyboard and/or mouse. The control system 228 may further include a non-volatile memory. The non-volatile memory may store instructions to activate motors to move inkjet printhead 218 in an x-direction and to dispense ink in desired locations as inkjet printhead 218 moves in the x-direction. In this way, a controlled pattern of binder may be delivered to desired locations as the current collector advances in the forward longitudinal direction to form a pattern in an x-y plane of current collector 204.

Current collector 204 including bound powder layer 222 may be passed under a powder dispensing unit to form a subsequent loose powder layer in face sharing contact with bound powder layer 222. In some examples, current collector 204 may be fed to a separate set of rollers and a different powder dispensing unit. In alternate examples, current collector 204 may be returned to powder dispensing unit 208. In further examples, a roll-to-roll system may include multiple powder dispensing units, each including a different powder composition. The loose powder layer may be formed by dispensing powder from one or more of the multiple powder dispensing units. In this way, multiple layers of powder and binder may be configured to form a three dimensional pattern which may be adjusted according to a desired density of particles. In some examples, the three dimensional pattern may include between two and five layers. In some examples, the three dimensional pattern may be a periodic engineered structure configured to direct flow of current through the electrode, hold electroactive material particles in place and to provide strength to the electrode structure when included in a battery cell. By including a minimal amount of solvent in the ink a drying time of the electrode before beginning the pre-assembly manufacturing process may be reduced.

Turning now to FIG. 3, a second embodiment of the electrode manufacturing system 300 using the binder jet system is illustrated. The second embodiment of the electrode manufacturing system 300 may include some of the same features as the first embodiment of the electrode manufacturing system 200. Such features are labeled the same as in FIG. 2 and may not be reintroduced.

The second embodiment of electrode manufacturing system 300 may include a build box 302. Build box 302 may include a build platform 304 and a platform support 306. Build platform 304 may be configured to move longitudinally forward and backwards along the y-axis. Build platform support 306 may be configured to move build platform 304 up and down along the z-axis. In this way, build platform 304 may advance a current collector 204 past powder dispensing unit 208, powder leveling and compacting unit 212, and binder jet system 216 to form a first electrode layer 308 on a first side 204a of current collector 204. Build platform 304 may advance current collector 204 multiple times. In this way, first electrode layer 308 may include multiple dispensed powder layers to form a three dimensional pattern of bound and unbound powder as described above with respect to FIG. 2. In some examples, current collector 204 may be slotted and notched before using electrode manufacturing system 300. Slotting and notching current collector 204 before electrode manufacturing may reduce cutting through already deposited layers of electroactive material particles, thereby reducing generation of fine particle dust and the accompanying process controls demanded to control the find particle dust. Additionally, discarding and subsequent waste of electroactive material bound to the portions of current collector removed during slotting and notching may be reduced.

Current collector 204 including first electrode layer 308 may be removed from build box 302 and rotated 180 degrees with about the y-axis or the x-axis and then placed back onto build platform 304 of build box 302 or into a different build box configured similarly to build box 302. In this way, a face of first electrode layer opposite from current collector 204 is in face sharing contact with the build plate. In some examples, first electrode layer 308 may be partially cured before rotating and placing on the build plate.

Loose powder layer 210, dense powder layer 214, and bound powder layer 222 may then be formed by passing a second side 204b of current collector 204 in a forward direction again past powder dispensing unit 208, powder leveling and compacting unit 212, and binder jet system 216. Second side 204b is opposite first side 204a across the z-axis. Loose powder layer 210 may be deposited by the powder dispensing unit 208 dispensing powder on the current collector 204. Loose powder layer 210 may be compacted by the powder leveling and compacting unit 212 into dense powder layer 214. Areas of dense powder layer may be bound with binder dispensed from the binder jet system 216 into bound powder layer 222. Multiple bound layers may be formed on the second side 204b to form a second electrode layer including a three-dimensional pattern of bound and unbound particles, as described above with respect to first electrode layer 208.

In this way, multi-layered electrodes may be formed, including a first electrode layer bound to a first side of a current collector and a second electrode layer bound to a second side of the current collector, the second side opposite the first. In some examples, a powder included in powder dispensing unit 208 may be different when forming loose powder layer 210 for the second electrode layer than when powder is dispersed and first electrode layer 308 is formed. In this way a multi-layered electrode with a first electrode layer and a second electrode layer may be formed and a composition of the first electrode layer may be different than a composition of the second layer. For example, the first electrode layer may include electroactive material particles at a first size distribution and the second electrode layer may include electroactive material particles at a second size distribution. As an alternate example, the first electrode layer may include cathode electroactive material particles and the second electrode layer may include anode electroactive material particles, the multi-layer electrode may be included in a bipolar battery cell.

Turning now to FIG. 4, an example of a method 400 is shown for an electrode manufacturing and pre-assembly process (e.g., electrode manufacturing process 104 and pre-assembly process 108 of FIG. 1) using jetting to distribute binder to a dense powder layer. Instructions for carrying out method 400 may be at least partially executed by a controller based on instructions stored on a memory of the controller and in conjunction with signals received from sensors of a manufacturing system. The controller may employ actuators of the manufacturing system which may include a binder jetting assembly to manufacture an electrode according to the methods described below. In one example, the manufacturing system may be a roll-to-roll manufacturing system as described above with respect to FIG. 2. In an alternate example, the manufacturing system may include a build box as described above with respect to FIG. 3.

At 402, method 400 includes coating a current collector with powder. Coating a current collector with powder may include dispensing powder onto the current collector with a powder dispensing unit, such as powder dispensing unit 208 of FIGS. 2-3. The powder includes electroactive material particles and may additionally include additives, such as conductive additives or thermally activated catalysts. Additionally, coating the current collector with powder may include compacting and leveling the powder on to the current collector using a powder leveling and compacting unit such as powder leveling and compacting unit 212 of FIGS. 2-3. Coating the current collector with powder may result in a densely packed powder layer on top of the current collector. In some examples, where the manufacturing system includes the build box, the current collector which is coated with powder may be notched and slotted current collector before the start of method 400.

At 404, method 400 includes jetting binder onto the coated current collector to form an electrode. Jetting binder may be performed by a binder jet system, such as binder jet system 216 of FIGS. 2-3. The binder jet system may be configured to introduce an ink comprised of binder and solvent onto the densely packed powder layer. The ink may be jetted at desired positions and at desired amounts based on instructions from a controller of the binder jet system. The jetted ink may bind together areas of the dense powder layer to itself and to the current collector to form a bound powder layer. In some examples, the ink may further include additive such as a conductivity enhancing additive or a thermally activated catalyst. The assembly of the bound powder layer fixedly coupled to and in face sharing contact with the current collector may be referred to as an electrode.

At 405, method 400 determines if additional layers are desired. If an additional layer is desired (YES), method 400 returns to 402 and the bound powder layer formed at 404 is re-coated with powder which is then leveled and compacted to form a densely packed powder layer. Binder is then jetted onto the densely packed powder layer to add a second bound powder layer to the electrode. The second layer may be in face sharing contact and fixedly coupled to the first layer. The positon and amounts of binder jetted may be different at the second layer than on the first layer. Steps 402 and 404 may be repeated multiple times. Each time binder may be jetted according to instructions generated by the controller of the binder jet system. In this way, a three dimensional pattern, such as a lattice or gyroid, of bound particles may be formed in a layer by layer fashion.

If method 400 determines that additional layers are not desired (NO), method 400 continues to step 406 and may include drying and curing the electrode. Drying the electrode may include removing solvent from the ink mixture and curing may include hardening of the binder polymer. Both drying and curing may be performed by directing a form of energy to the electrode. The amount of solvent used in the ink jetted onto the dense powder layer at 404 may be minimized to reduce the amount of time demanded for step 406. The same energy source may be used for drying and curing, thereby performing drying and curing at the same time. Due to a relatively small amount of solvent, drying may be a finished before curing is finished, and curing may be the time limiting factor of step 406. In one example, drying and curing the electrode may include drying and curing using radiative thermal energy in an oven. In alternate examples, drying and curing the electrode may include using energy transferred by photons. The photons may be coherent (e.g., a laser) on incoherent. As a non-limiting example, the photons may be ultraviolet photons and/or infrared photons. In a further example, drying and curing may include using energy from electrons using an electron beam.

At 412, method 400 determines if an additional electrode layer is desired. If an additional electrode layer is desired (YES), method 400 returns to 402 and a second uncoated side of the current collector is coated as described above with respect to steps 402-410 and a second electrode layer is formed on the current collector. In some examples, a powder coating the uncoated current collector to form the second electrode layer may include different particles (such as different electroactive particles or different additives) from the particles of the powder coating of a first electrode layer. If an additional electrode layer is not desired (NO), then method 400 optionally proceeds steps 408 and 410 or directly to step 418.

In some examples, when the current collector is not slit or notched before coating with powder, then method 400 proceeds to slit the electrode at step 408 followed by notching the electrode at step 410. Slitting the electrode may include cutting edges of the current collector to a size demanded by the battery cell casing. The binder may be jet onto the current collector so that binder is not present on the portions of the dense powder layer that are trimmed away by slitting the electrode. Without the binder present, the dense powder layer may be readily removed from the current collector sections trimmed during slitting. In this way, the powder, including electroactive material particles, may be recycled by reintroducing the powder to the powder dispensing unit.

At 410, method 400 includes notching the electrode. Notching the electrode may include cutting the current collector to form tabs. The binder may be jet onto the current collector at step 404 so that binder is not present on a portion of the current collector removed by notching. Without binder present, the dense powder layer may be readily removed from the portion of current collector removed by notching. In this way, the powder including the electroactive material particles, may be recycled.

At 418, method 400 includes assembling the battery cell. The process of battery cell assembly may be the next step in manufacturing a battery array using the electrode produced as described above with respect to FIG. 1. Method 400 ends.

Turning now to FIG. 5A, it illustrates an inkjet nozzle 502 directing an ink (e.g., including binder and solvent) droplet 504 towards a densely packed powder layer 506. Inkjet nozzle 502 may be part of an inkjet printhead, such as inkjet printhead 218 and the densely packed powder layer may be similar to dense powder layer 214. Densely packed powder layer 506 may include voids 508 between particles of the densely packed powder layer. FIG. 5B shows a section 510 of densely packed powder layer 506 after the ink droplet reaches densely packed powder layer 506. Voids 508 may be at least partially filled by in by ink 512. Ink 512 may be derived from ink droplet 504. After drying, the solvent may be removed from the ink, leaving behind the binder and any other additives included in the ink. After curing, the binder may fixedly couple particles of the densely packed particle layer to each other and to a current collector. By repeatedly dispensing the ink selectively across a surface of a densely packed particle layer in a layer by layer fashion as described above with respect to method 400, a three dimensional pattern, such as a lattice or gyroid, of bound particles may be formed.

An example of a layer of binder which may be jet by an inkjet printhead onto the densely packed particle layer, viewed down the z-axis with respect to the manufacturing direction shown in FIGS. 2-3, is shown at different magnifications in FIGS. 6A-6B and in a three dimensional representation in FIG. 6C. FIG. 6A shows an example of a layer 600 of ink deposited by the inkjet printhead. Layer 600 may include bound areas 602 as well as unbound areas 604. The dots on layer 600 may denote bound areas 602 where ink is deposited and the white areas may denote unbound areas 604. FIG. 6B looks closer at a section 601 of layer 600. A bound area 602 and an unbound area 604 may be shaped to form a layer of a desired three dimensional pattern of bound areas. Dimensions and placement of the bound areas may be adjusted by instructions stored on a controller of the binder jet system to determine slices of the desired three dimensional pattern. An example of a three dimensional pattern 650 is shown in FIG. 6C. Three dimensional pattern 650 may be an example of a multi-layered electrode including a current collector 652 and a first pattern 654 positioned on a first side 662 of the current collector and a second pattern 656 positioned on a second side of the current collector, opposite the first side 662 across the z-axis. First pattern 654 and second pattern 656 may both include bound volumes 658. Bound volumes 658 may be formed by multiple layers of bound areas, such as bound areas 602 of FIGS. 6A-6B. Additionally unbound volumes 660 may be present between bound volumes 658. Both bound volumes 658 and unbound volumes 660 may include electroactive material particles. Electroactive material particles in bound volume 658 may be fixedly coupled to each other by binder while electroactive material particles in unbound volumes 660 may secured between bound volumes 658 without binder by close packing.

Bound areas 602 may further include areas (e.g., pixels) where ink is dispersed and where ink is not dispersed as described further below with respect to FIG. 7. Turning now to FIG. 7, an example of a lightly inked area 702 and a heavily inked area 704. Lightly inked area 702 may include portions that are inked (shown as black pixels) and portions that are not inked (shown as white pixels). Heavily inked area 704 shows may not include portions that are not inked. Said another way, a fraction of the pixels of lightly inked area 702 include ink and each pixel of heavily inked area 704 includes ink. By adjusting a number of areas which are inked or not inked within an inked portion, an amount of solvent and binder used in manufacturing the electrode may be minimized while still providing adequate adhesion of the electroactive material particles to each other and to the current collector. A three dimensional pattern of bound volumes, such as first pattern 654 and second pattern 656 may include both heavily inked portions and lightly inked portions. For example, portions of the three dimensional pattern under higher mechanical stress during cell manufacturing and battery array assembly may be heavily inked portions and those under less mechanical stress may be lightly inked portions.

Turning now to FIG. 8, an alternate example of a three dimensional pattern 800 formed by jetting binder at a densely packed powder layer in a layer by layer manner is shown. An axis 801 is shown for comparison between the photograph of FIG. 8 and the magnified portion shown in FIG. 9. The z-axis may correspond to a vertical direction and the direction in which three dimensional pattern 800 is built (e.g., via the manufacturing process shown in FIG. 2 or 3) three dimensional pattern 800 is formed as a test using particles on a substrate 803. As one example, a ratio of binder to solvent ratio in the ink jetted at the particles may be between 10% and 20% by weight. Additionally, the binder may comprise less than or equal to 3% by weight of the electrode after drying and curing.

Three dimensional pattern 800 may be formed of multiple powder and inked layers, each including bound areas and unbound areas configured to form three dimensional pattern 800. Three dimensional pattern may include bound volumes 802 and unbound volumes 804 in alternating layers along the x-axis. Bound volumes 802 may include binder and steel particles and unbound volumes 804 may include steel particles without binder. The steel particles without binder may be secured to the substrate due to being wedged between bound volumes 802.

The particles of three dimensional pattern 800 may be replaced with electroactive active material particles, to make three dimensional pattern 800 appropriate for a battery electrode. A two dimensional slice 900 of a three dimensional pattern, such as three dimensional pattern 800, including electroactive material particles and binder, is shown in FIG. 9. Bound areas 902 may include electroactive material particles and binder, binding the electroactive material particles to each other as shown in FIG. 5B. Unbound electroactive material particles 904 may be wedged between bound areas 902. Because of the insulating nature of the binder, ions (e.g., lithium ions) diffusing through the electrode during charging and discharging of the battery cell may preferentially follow a path shown by arrow 906 through the unbound electroactive material particles 904. In this way, a pathway of ions through the electrode may be directed by a three dimensional pattern of bound volumes. Directing ion pathways in this manner may help enable fast charging and discharging of batteries.

A distance between bound volumes may vary across a volume of the three dimensional pattern. As shown in two dimensional slice 900, bound areas 902 may be spaced apart by a first distance 908 and a first end 910 of two dimensional slice 900. Bound areas 902 may be angled such that bound areas 902 are separated by a second distance 912 at a second end 914 of two dimensional slice 900. First end 910 may be opposite second end 914 along the x-axis. Electroactive material particles closer to first end 910 may be packed less densely than electroactive material particles closer to second end 914. In some examples, densities of unbound electroactive material particles may vary by between 20% and 70% based on a three dimensional pattern of the bound volumes. In this way, the three dimensional pattern of bound volumes may be used to adjust a density electroactive material particles secured between the bound volumes. Density of the unbound electroactive material particles may be adjusted to account for swelling of the electrode during multiple charging and discharging cycles of the battery cell. As one example, bound volumes may be spaced far apart to a decrease the density of electroactive material particles in portions of the electrode prone to swelling and spaced close together to increase the density of electroactive material particles in portions of the electrode not prone to swelling. In this way, swelling of the electrode may be mitigated while still maintaining a desired power density of the battery cell.

Technical effect of using binder jetting to apply binder during electrode manufacturing is to decrease an amount of solvent used in the process and enable controlled formation of a three dimensional pattern of bound electroactive material particles. Decreasing the amount of solvent may decrease the drying time demanded for electrode manufacturing, thereby increasing an efficiency of the electrode manufacturing process. Additionally, using the binder jet system may decrease a demanded amount of binder which may help increase a conductivity of the electrode. Further the binder jet system may enable formation of three dimensional patterns of bound electroactive material particles and unbound electroactive material particles and the layer by layer process may allow for layer by layer tuning of properties within an electrode which is not available with slurry based methods. The three dimensional pattern may be configured to direct lithium diffusion in desirable directions through the electrode. Additionally, the three dimensional pattern may be formed to adjust density of unbound electroactive material particles to compensate for swelling of the electroactive material. Further, the binder jet system may enable selective addition of additional materials to the electrode (e.g., catalysts or conductivity additives), either in the powder layer or in the inked layers.

FIGS. 2-3, 5A-6C, and 8-9 show example configurations with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

1. A method, comprising:
coating powder onto a first side of a current collector, wherein the powder includes electroactive material particles;
jetting an ink including a binder in a controlled pattern onto the powder coated first current collector; and
forming an electrode including patterned areas of bound powder and unbound powder, wherein the unbound powder is secured between the patterned areas of bound powder.

2. The method of claim 1, further comprising:
coating a second side of the current collector with powder, the second side opposite the first side.

3. The method of claim 2, wherein coating powder onto the first side of the current collector includes coating with a first powder and coating powder onto the second side of the current collector includes coating with a second powder, wherein a composition of the first powder is different from a composition of the second powder.

4. The method of claim 3, wherein the first powder include cathode electroactive material and the second powder includes anode electroactive material.

5. The method of claim 1, further comprising:
slitting and notching the current collector before coating powder onto the first side of the current collector.

6. The method of claim 1, wherein the ink further includes one or more of a conductivity enhancing dopant, or a thermally activated catalyst.

7. The method of claim 1, wherein the method is performed using a roll-to-roll process or using a build box.

8. An electrode for a battery cell, comprising:
a current collector;
a three dimensional pattern including volumes of bound electroactive material particles fixedly coupled to the current collector; and
unbound electroactive material particles secured between the volumes bound electroactive material particles.

9. The electrode of claim 8, wherein the volumes of bound electroactive material particles are configured to determine a pathway of ions through the electrode.

10. The electrode of claim 8, wherein a distance between volumes of bound electroactive material particles determines a density of the unbound electroactive material particles secured between the volumes of bound electroactive material particles.

11. The electrode of claim 10, wherein the density of the unbound electroactive material particles is configured to allow for swelling of the unbound electroactive material particles.

12. The electrode of claim 8, wherein the volumes of bound electroactive material particles include a conductivity enhancing dopant.

13. The electrode of claim 8, wherein the electrode is a multi-layered electrode including the three dimensional pattern fixedly coupled to a first side of the current collector and fixedly coupled to a second side of the current collector, the first side opposite the second side.

14. The electrode of claim 8, wherein the three dimensional pattern is a periodic engineered structure configured to hold unbound particles, provide strength to a battery cell including the electrode, and to direct current flow through the electrode.

15. A method, comprising:
forming a densely packed powder layer in face sharing contact with a current collector;
jetting binder in a selected areas of the densely packed powder layer to form an electrode, wherein the selected areas include a heavily inked area and/or a lightly inked area; and
drying and curing the electrode.

16. The method of claim 15, wherein jetting the binder in the heavily inked area includes jetting binder at each pixel of the selected areas and jetting the binder in the lightly inked area includes jetting binder at a fraction of pixels of the selected areas.

17. The method of claim 15, further comprising slitting and notching the electrode, and wherein jetting the binder in selected areas includes not jetting binder in areas of the electrode removed during slitting and notching.

18. The method of claim 17, further comprising recycling powder from the areas of the electrode removed during slitting and notching.

19. The method of claim 15, wherein drying and curing the electrode includes drying and using an energy source, wherein drying is finished before curing is finished.

20. The method of claim 15, wherein forming a densely packed powder includes dispensing powder onto the current collector and compacting and leveling the dispensed powder.
